(19) United States
(12) Patent Application Publication
(10) Pub. No.: US 2024/0300352 A1
(43) Pub. Date: Sep. 12, 2024

(54) DEVICE WITH AN ELECTRICAL CHARGING SYSTEM FOR AN ELECTRICALLY DRIVEN MOBILE WORK MACHINE

(71) Applicant: DEERE & COMPANY, MOLINE, IL (US)

(72) Inventor: FRANK BUHRKE, BIRKENAU (DE)

(21) Appl. No.: 18/444,910

(22) Filed: Feb. 19, 2024

(30) Foreign Application Priority Data
Mar. 6, 2023 (DE) 102023105441.4

(51) Int. Cl. B60L 53/30; B60L 53/18; B60L 53/50; B60L 53/60

(52) U.S. Cl. CPC B60L 53/30; B60L 53/18; B60L 53/50; B60L 53/60

(57) ABSTRACT

A device in the form of a mobile trailer includes an electrical charging system for electrically charging a drive battery of an electrically driven mobile work machine. The device can attach to a towing vehicle.

### CROSS-REFERENCE TO RELATED APPLICATIONS

This application claims priority to German Patent Application No. 102023105441.4, filed Mar. 6, 2023, which is hereby incorporated by reference.

### FIELD OF THE DISCLOSURE

The disclosure relates to a device with an electrical charging system for an electrically driven mobile work machine.

### BACKGROUND

Electric work vehicles need to be recharged during work operations.

### SUMMARY

An electric battery drive for electrically driven mobile work machines can be a logistical challenge especially in the agricultural sector in daily use, in particular during work deployments in the field.

The object of the present disclosure is therefore to efficiently assist the logistics for an electric battery drive of an electrically driven mobile work machine, in particular of an electrically driven agricultural vehicle.

This object is achieved by a device having the features of one or more of the following embodiments.

Further advantageous embodiments of the device according to the disclosure can be found herein.

According an embodiment, a device has an electrical charging system for electrically charging a drive battery of an electrically driven mobile work machine. The device takes the form of a mobile trailer for attachment to a towing vehicle. The electrically driven mobile work machine is in particular an electrically driven agricultural vehicle.

The device thus has a mobile design and can therefore be transported flexibly to different deployment locations of the electrically driven mobile work machines scheduled therefor. In the case of electrically driven agricultural vehicles, their electric drive can consequently be assisted in a field and in particular during a work deployment by the electrical charging system of the device being available on site. As a result, electrical energy can be supplied for the electrically driven mobile work machines or agricultural vehicles during their work deployments, independently of conventional supply networks. In this way, the device offers advantageous logistical assistance especially when agricultural work is being carried out by electrically driven agricultural vehicles.

The abovementioned towing vehicle for transporting the mobile device is, for example, a tractor, a tractor unit of a truck, or an all-terrain vehicle.

The mobile device can be towed by means of the towing vehicle to the deployment location of the electrically driven mobile work machines or agricultural vehicles, in particular to a field. The mobile device can be coupled reversibly (i.e. removably) to the towing vehicle. For this purpose, the mobile device can have a suitable coupling unit.

The electrically driven mobile work machine or the agricultural vehicle can be a tractor.

In an embodiment, the device has a platform for carrying at least one electrically driven mobile work machine. As a result, electrically driven mobile work machines can also be transported at the same time by the charging system in an energy-saving fashion to the planned deployment location.

The electrical charging system of the device has at least one charging station for electrically charging a drive battery of the respective electrically driven mobile work machine. Specifically adapted charging capacities can be supplied by means of the charging station or stations depending on the electrically driven mobile work machines used. For this purpose, the charging station contains a suitable buffer battery for storing electrical energy which can be output to the respective electrically driven mobile work machine.

In an embodiment of the device, the charging station is arranged removably on the device. As a result, charging stations can be set down flexibly at the respective deployment location of the electrically driven mobile work machines, which further improves the logistical assistance of the electric drive. Moreover, in this way mobile charging stations can be maintained or repaired more easily. Furthermore, the device can also be used without the charging stations for other purposes or transporting tasks.

A modular structure of the device with mobile charging stations which can be removed from it can be produced technically in a particularly efficient fashion by the device having a maneuverable moving apparatus (for example a crane, forklift, tilting mechanism) which is suitable for moving the charging station from its transport position into a different position outside the device. As a result, the respective charging station can be set down with minimal effort specifically at a certain position, for example in the field, and operated where it is actually needed.

Similarly to the charging station, the moving apparatus itself is also arranged removably on the device. As a result, the mobile device can also be used without a moving apparatus for other purposes or transporting tasks.

The charging station has a charging cable for electrically charging a drive battery of an electrically driven mobile work machine or an electrically driven agricultural vehicle. As a result, the drive battery can be charged not only in the field but also during transporting of the electrically driven mobile work machine or the agricultural vehicle by means of the device. This increases the working efficiency of the respective electrically driven mobile work machine.

In an embodiment, the electrical charging system of the device has one or more current storage units. The latter can take the form of buffer batteries with the highest possible capacity. The current storage unit or units can be electrically connected to the charging station or stations via a suitable electrical connection, in particular a high-voltage connection, in the region of the device. The current storage units arranged on the device offer the possibility of recharging the charging stations as required while they are being transported by means of the device and, for example, in the field too. As a result, the charging stations can be provided with a full charging capacity for as long a period as possible, which makes the supplying of electrical energy to the electrically driven mobile work machines even more efficient.

The current storage unit is arranged on a side or an underside of the device such that trouble-free maneuvering and positioning of the electrically driven mobile work machines and/or the charging station on the device is assisted.

For example, the current storage unit is arranged removably on the device such that it only has to be transported with the device when needed. As a result, the mobile device can be adapted individually to the respective use case.

The charging station and/or the current storage unit each have a current interface for receiving electrical energy from a power grid. The charging stations and/or current storage units used can thus be recharged technically simply and quickly as soon as a power grid, an electrical energy source, or the like is available.

In an embodiment, the device has a control system, in particular an electronic control unit (e.g., a controller including a processor and memory), for controlling the operation of the electrical charging system. For example, the control system can contain one or more charging strategies according to which the available electrical energy is distributed as efficiently as possible. It can also comprise prioritization of the energy source (power grid or current storage unit) for recharging the charging station. The control system can furthermore control in an open or closed loop the electrical energy flow between the existing current storage units, the charging stations, and the drive batteries of the electrically driven mobile work machines while the mobile device is being transported or at the deployment location of the electrically driven mobile work machines. A supply of electrical energy to the towing vehicle towing the device can also be controlled by the control system in an open or closed loop.

In a further function, the control system can also include heat management for the charging stations and/or current storage units. This assists operation of the charging stations and/or the current storage units with charging behavior which is as efficient as possible. The control system can here be combined with a cooling and/or heating apparatus in order to produce optimal temperature conditions for all charging stations and/or current storage units used.

The above and other features will become apparent from the following detailed description and accompanying drawings.

### BRIEF DESCRIPTION OF THE DRAWINGS

The device according to the disclosure will be explained in more detail hereinafter with reference to the attached drawings.

FIG. 1 shows a schematic side view of a mobile device with an electrical charging system, according to an embodiment.

### DETAILED DESCRIPTION

The embodiments or implementations disclosed in the above drawings and the following detailed description are not intended to be exhaustive or to limit the present disclosure to these embodiments or implementations.

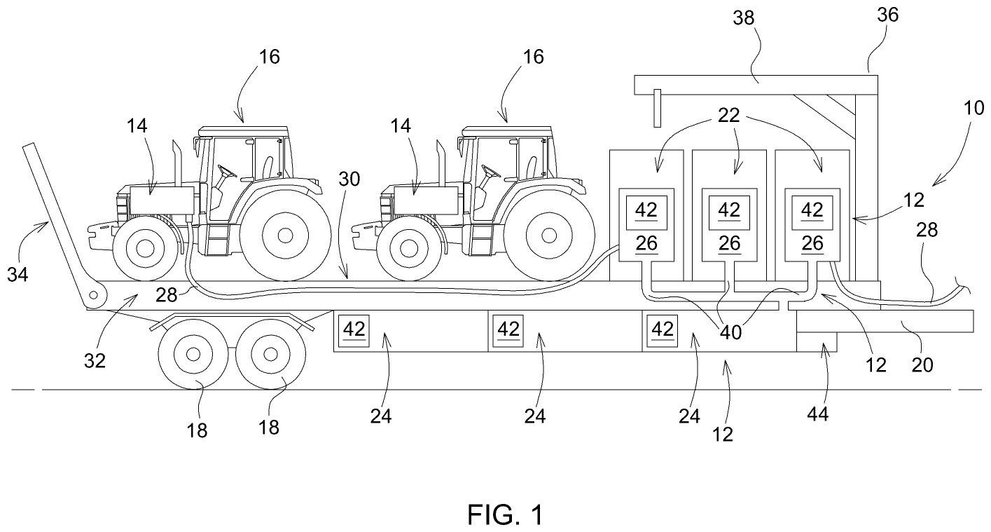

FIG. 1 shows a schematic side view of a mobile device 10 according to an embodiment with an electrical charging system 12 for electrically charging a drive battery 14 of an electrically driven mobile work machine in the form of an electrically driven agricultural vehicle 16, in the form of a tractor as illustrated here.

The device 10 takes the form of a mobile trailer with a plurality of wheels 18 and a coupling unit 20. By means of the schematically illustrated coupling unit 20, the mobile device 10 can be coupled or attached to a towing vehicle (not illustrated here) and be towed to the deployment location of the agricultural vehicles 16, in particular in the field.

The electrical charging system 12 has optionally one or more charging stations 22 and optionally one or more current storage units 24.

In each case one buffer battery 26 for storing electrical energy is integrated into the charging stations 22. The buffer batteries 26 are in each case electrically connected to a charging cable 28. The charging station 22 can electrically charge the drive battery 14 of the respective agricultural vehicle 16 via the charging cable 28. The electrical charging can take place, for example, while the agricultural vehicle 16 is being transported on the device 10 or at the deployment location, for example in the field.

For transporting the agricultural vehicles 16, the device 10 has a platform 30 which is a constituent part of an essentially horizontally oriented transport frame 32. While the coupling unit 20 is fastened at one end section of the transport frame 32, a loading flap 34 is situated at an opposite end section of the transport frame 32. The loading flap is mounted (in particular pivotably) on the transport frame 32 and can, in the pivoted position illustrated, contribute to securing the position of the agricultural vehicles 16 while they are being transported. In a pivoted-down position, the loading flap 34 can serve as a drive-on drive-off ramp for the agricultural vehicles 16 so that the latter are, for example, driven off the transport frame 32 and into the field or are driven from the field onto the transport frame 32.

In addition to the agricultural vehicles 16, a plurality (in this case, three) charging stations 22 are positioned on the transport frame 32. The charging stations 22 are arranged removably on the mobile device 10 such that the number of charging stations 22 required for the respective intended purpose can be transported.

A maneuverable moving apparatus 36 (illustrated schematically here) is arranged on the device 10. It is used to move the charging station 22 from its transport position on the device 10 into a different position outside the device 10 such that the charging station 22 can be positioned as a mobile unit, for example, in the field at the desired place. Conversely, the charging station 22 can be lifted by means of the moving apparatus 36 from the field and back into its transport position on the transport frame 36. Moreover, individual charging stations 22 can be easily exchanged and replaced at a desired maintenance and repair facility by means of the moving apparatus 36.

The moving apparatus 36 is configured, for example, in the manner of a crane. The moving apparatus 36 can take hold of the charging station 22 by means of a maneuverable, in particular pivotable, gripper arm 38 and transfer it to the desired position.

As already mentioned, the electrical charging system 12 of the mobile device 10 has at least one current storage unit 24. In the exemplary embodiment illustrated, three current storage units 24 are provided which are arranged on an underside of the transport frame 32. The current storage units 24 are arranged or mounted removably on the transport frame 32 as modules such that the number of current storage units 24 required for the respective intended purpose can always be transported.

The current storage units 24 are electrically connected to the charging stations 22 via a suitable electrical connection 40, in particular a high-voltage connection. It is also possible to connect a plurality of current storage units 24 in parallel in order to further increase the charging capacity. The current storage units 24 arranged on the device serve to recharge the charging stations 24, or thereby the drive battery 14 of the respective agricultural vehicle 16, as required while they are being transported by means of the device and, for example, in the field too.

The charging stations 22 and the current storage units 24 each have a current interface 42 and can consequently be recharged quickly at corresponding charging devices of the public grid.

The device 10 moreover has a control system 44 for controlling the operation of the electrical charging system 12. The control system 44 takes the form of a control unit (e.g., a controller including a processor and memory) and is arranged at a suitable position of the device 10, for example on an underside of the transport frame 32. In order to distribute the available electrical energy as efficiently as possible while the mobile device 10 is being transported by a towing vehicle or at the deployment location of the agricultural vehicles 16, the control system 44 is connected electronically or electrically to the electrical charging system 12. As a result, the control system 44 can control in an open or closed loop the electrical energy flow between the existing current storage units 24, the charging stations 22, and the drive batteries 14 of the agricultural vehicles 16. A supply of electrical energy to the towing vehicle towing the device 10 can also be controlled by the control system 44 in an open or closed loop.

In a further function, the control system 44 can also include heat management for the charging stations 22 and/or current storage units 24. As a result, charging behavior which is as efficient as possible is assisted during the operation of the charging stations 22 and/or the current storage units 24. The control system 44 can be combined with a cooling and/or heating apparatus (not illustrated here) in order to produce optimal temperature conditions for all charging stations 22 and/or current storage units 24 used.

For the sake of completeness, it should be pointed out that individual illustrated details are not true to scale schematically and/or relative to one another.

The terminology used herein is for the purpose of describing example embodiments or implementations and is not intended to be limiting of the disclosure. As used herein, the singular forms “a,”“an,” and “the” are intended to include the plural forms as well, unless the context clearly indicates otherwise. It will be further understood that the any use of the terms “has,”“includes,”“comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,”“below,”“upward,”“downward,”“top,”“bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,”“substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,”“including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A device in the form of a mobile trailer, comprising:
an electrical charging system for electrically charging a drive battery of an electrically driven mobile work machine;
wherein the mobile trailer can attach to a towing vehicle.

2. The device of claim 1, further comprising a coupling unit for coupling to the towing vehicle.

3. The device of claim 1, further comprising a platform for carrying at least one electrically driven mobile work machine.

4. The device of claim 1, wherein the electrical charging system has at least one charging station for electrically charging a drive battery of the electrically driven mobile work machine.

5. The device of claim 4, further comprising a maneuverable moving apparatus for moving the charging station from its transport position on the mobile trailer into a different position outside the mobile trailer.

6. The device of claim 1, wherein the charging station has a charging cable for electrically charging a drive battery of the electrically driven mobile work machine.

7. The device of claim 1, wherein the electrical charging system has at least one current storage unit which is electrically connected to at least one charging station via an electrical connection.

8. The device of claim 7, wherein the current storage unit is arranged removably on the device.

9. The device of one of claim 1, wherein the charging station and the current storage unit each have a current interface for receiving electrical energy.

10. The device of claim 1, further comprising a control system for controlling the operation of the electrical charging system.
